(19) United States
(12) Patent Application Publication
(10) Pub. No.: US 2024/0209990 A1
(43) Pub. Date: Jun. 27, 2024

(54) FUEL CELL ELECTRIC VEHICLE

(71) Applicant: TOYOTA JIDOSHA KABUSHIKI KAISHA, Aichi-ken (JP)

(72) Inventors: Tomohiro SHINAGAWA, Shizuoka-ken (JP); Yuchi YAMANOUCHI, Toyota-shi (JP); Takuro MIZUSHIMA, Susono-shi (JP)

(21) Appl. No.: 18/537,805

(22) Filed: Dec. 13, 2023

(30) Foreign Application Priority Data
Dec. 26, 2022 (JP) 2022-207985

(51) Int. Cl. F17C 13/08

(52) U.S. Cl. CPC F17C 13/084; F17C 2201/0109; F17C 2221/012; F17C 2270/0168

(57) ABSTRACT

The fuel cell electric vehicle includes a pair of side rails extending in the longitudinal direction of the vehicle, a lower cross member that connects the pair of side rails in the vehicle width direction below the pair of side rails, a hydrogen tank mounted on the lower cross member, and an upper cross member that connects the pair of side rails in the vehicle width direction above the hydrogen tank.

### CROSS REFERENCE TO RELATED APPLICATION

This application claims priority to Japanese Patent Application No. 2022-207985 filed on Dec. 26, 2022, which is incorporated herein by reference in its entirety including the specification, claims, drawings, and abstract.

### TECHNICAL FIELD

The present disclosure relates to a structure of a fuel cell electric vehicle.

### BACKGROUND

JP2022-29621A discloses a structure in which a hydrogen tank is held in a fuel cell electric vehicle. In this structure, a tank mounting frame having a rectangular frame shape is fixed to a structural member of a vehicle body, and a hydrogen tank is suspended from the tank mounting frame by a restraint band.

### SUMMARY

In the structure described in JP2022-29621A, since it is necessary to provide a tank mounting frame in addition to the structural members of the vehicle body, the weight of the vehicle may increase. Further, since the strength member is not disposed in the space in which the hydrogen tank is suspended, the strength of the structural member of the vehicle body may not be sufficiently high.

Accordingly, it is an object of the present disclosure to provide a fuel cell electric vehicle which is lightweight and improves structural strength of a vehicle body.

A fuel cell electric vehicle according to the present disclosure includes: a pair of side rails extending along a vehicle longitudinal direction; a lower cross member disposed below the pair of side rails so as to connect the pair of side rails in a vehicle width direction; at least one hydrogen tank mounted on the lower cross member; and an upper cross member disposed above the hydrogen tank so as to connect the pair of side rails in a vehicle width direction.

According to the present disclosure, since the side rail is used as the hydrogen tank support structure, the weight of the fuel cell electric vehicle can be made lighter than in the case where the tank mounting frame is provided separately from the structural member of the vehicle body as in the structure described in JP2022-29621A. Further, by providing the upper cross member and the lower cross member, the rigidity of the vehicle body frame can be improved.

In the fuel cell electric vehicle of the present disclosure, the upper cross member and the lower cross member may be disposed at different positions in the vehicle longitudinal direction.

Thus, the rigidity of the vehicle body frame can be improved.

In the fuel cell electric vehicle according to the present disclosure, the hydrogen tank may be cylindrical, and the hydrogen tank may be mounted on the lower cross member such that a longitudinal direction of the hydrogen tank is a longitudinal direction of the vehicle, and the upper cross member may be curved upward and convex along a cylindrical surface of the hydrogen tank.

Since the upper cross member is curved upward along the cylindrical surface of the hydrogen tank, the minimum ground height of the hydrogen tank can be increased while reducing the floor of the vehicle.

In the fuel cell electric vehicle of the present disclosure, the hydrogen tank may have a cylindrical shape, and may include a plurality of tanks mounted on the lower cross member so that a longitudinal direction of the hydrogen tank becomes a longitudinal direction of the vehicle. The upper cross member may be curved upward along cylindrical surfaces of the plurality of hydrogen tanks to define positions of the plurality of hydrogen tanks in the vehicle width direction.

This makes it possible to define the position of the hydrogen tank in the vehicle width direction with a simple configuration.

In the fuel cell electric vehicle of the present disclosure, the hydrogen tank may have a cylindrical shape, and may include a plurality of tanks mounted on the lower cross member so that a longitudinal direction of the hydrogen tank becomes a longitudinal direction of the vehicle. The lower cross member may include a plurality of brackets, each bracket being attached to an outer surface of a corresponding one of the side rails in the vehicle width direction and extending downward from the corresponding one of the side rails, and a cross rail connecting the brackets in the vehicle width direction. Each bracket may be provided with a plurality of stoppers. Each stopper may be attached to a respective lower end of the bracket and an upper surface of the cross rail. The plurality of stoppers may define the position of each hydrogen tank in the vehicle width direction.

This makes it possible to define the position of the hydrogen tank in the vehicle width direction.

The present disclosure can provide a fuel cell electric vehicle which is lightweight and has improved structural strength of a vehicle body.

### BRIEF DESCRIPTION OF DRAWINGS

Embodiment(s) of the present disclosure will be described based on the following figures, wherein:

FIG. 1 is a side view of a fuel cell electric vehicle according to an embodiment;

FIG. 2 is a plan view showing a frame, an upper cross member, and a lower cross member of the fuel cell electric vehicle according to the embodiment;

FIG. 3 is a side view showing a frame, an upper cross member, a lower cross member, and a hydrogen tank of the fuel cell electric vehicle according to the embodiment;

FIG. 4 is an elevation view of a frame, an upper cross member, a lower cross member, and a hydrogen tank of the fuel cell electric vehicle of the embodiment as viewed from the front, taken along the line B-B shown in FIG. 2;

FIG. 5 is a front elevation view of a frame, an upper cross member, a lower cross member, and a hydrogen tank of a fuel cell electric vehicle according to another embodiment of the present disclosure.

### DESCRIPTION OF EMBODIMENTS

Hereinafter, a vehicle 100 according to an embodiment of the present disclosure will be described with reference to the drawings. The vehicle 100 is a fuel cell electric vehicle traveling by the fuel cell 20. Arrows FR, UP, and RH shown in the drawings indicate the front side, the upper side, and the right side of the vehicle 100, respectively. The opposite directions of the arrows FR, UP, and RH indicate the rear side, the lower side, and the left side. Hereinafter, in the case of simply using the front-rear direction, the left-right direction, and the up-down direction, unless otherwise specified, the front-rear direction, the left-right direction, and the up-down direction of the vehicle 100 are indicated.

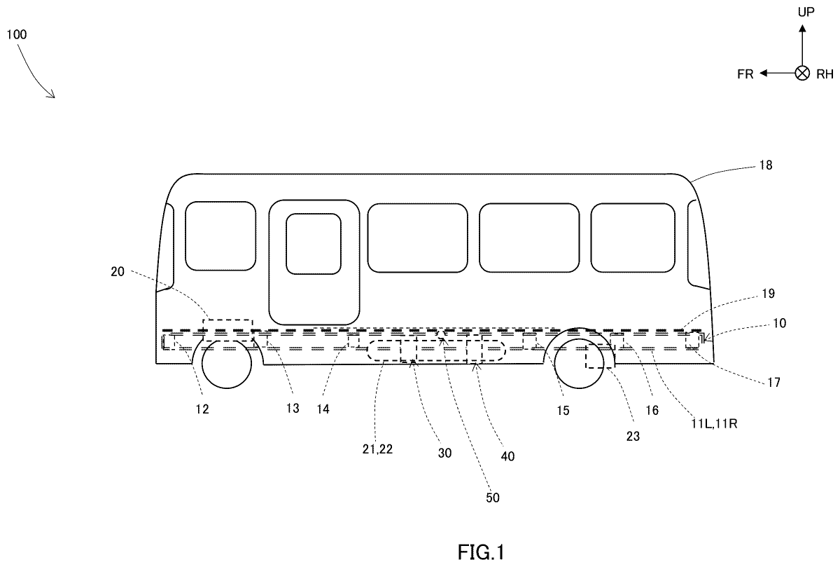

As shown in FIG. 1, the vehicle 100 is a frame vehicle in which a body 18 is mounted on a frame 10. A floor 19 of the vehicle 100 is mounted on the frame 10. The vehicle 100 includes a fuel cell 20, a driving motor 23, and two hydrogen tanks 21 and 22. Lower cross members 30, 40 and an upper cross member 50 are attached to the frame 10. The hydrogen tanks 21 and 22 are cylindrical shape, and semi-spherical mirror plates are attached to both ends. The hydrogen tanks 21 and 22 are mounted on the vehicle 100 such that the longitudinal direction thereof is the longitudinal direction of the vehicle.

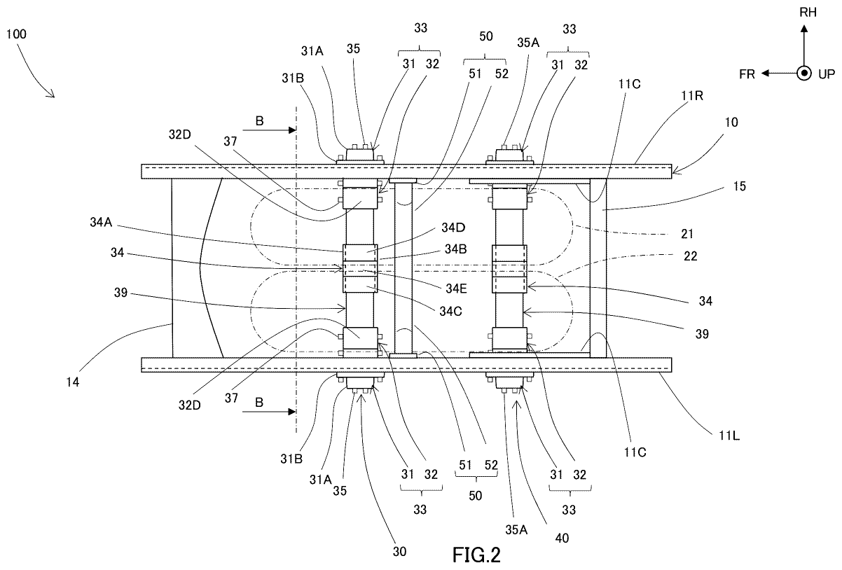

As shown in FIGS. 1 and 2, the frame 10 includes a left side rail 11L, a right side rail 11R, and first to sixth cross members 12 to 17 that connect the left and right side rails 11L and 11R in the vehicle width direction. The frame 10 is a ladder-type skeleton member. The left and right side rails 11L and 11R are groove-shaped cross-sectional members whose inner sides in the vehicle width direction are open.

A front lower cross member 30 and a rear lower cross member 40 are provided between the third cross member 14 and the fourth cross member 15 provided at the center of the frame 10. Hereinafter, the configuration of the front lower cross member 30 will be described.

As shown in FIGS. 2 to 4, the front lower cross member 30 includes a bracket 33 and a lower cross rail 39. The bracket 33 is attached to the outer surfaces of the left and right side rails 11L and 11R in the vehicle width direction, and extends downward from the left and right side rails 11L and 11R. The lower cross rail 39 is a longitudinal member having a groove-shaped cross section connecting the lower ends of the brackets 33 on both sides in the vehicle width direction.

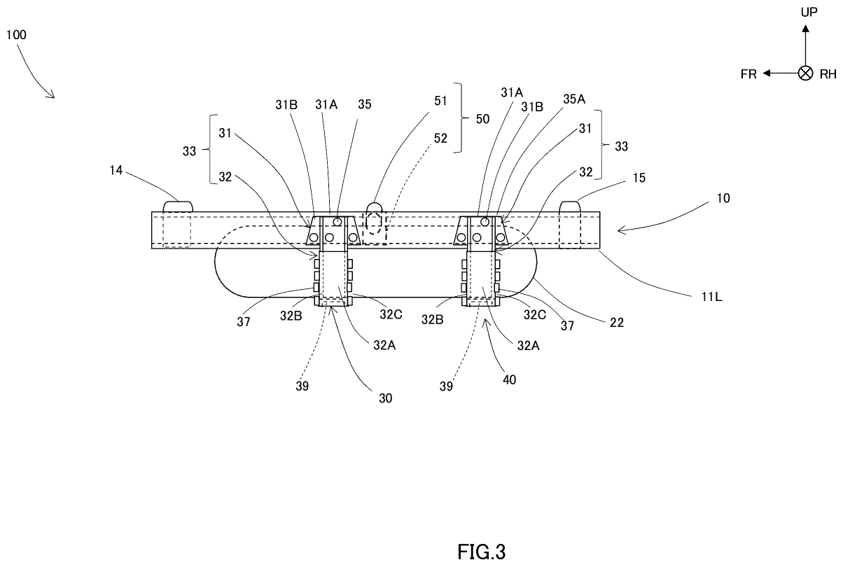

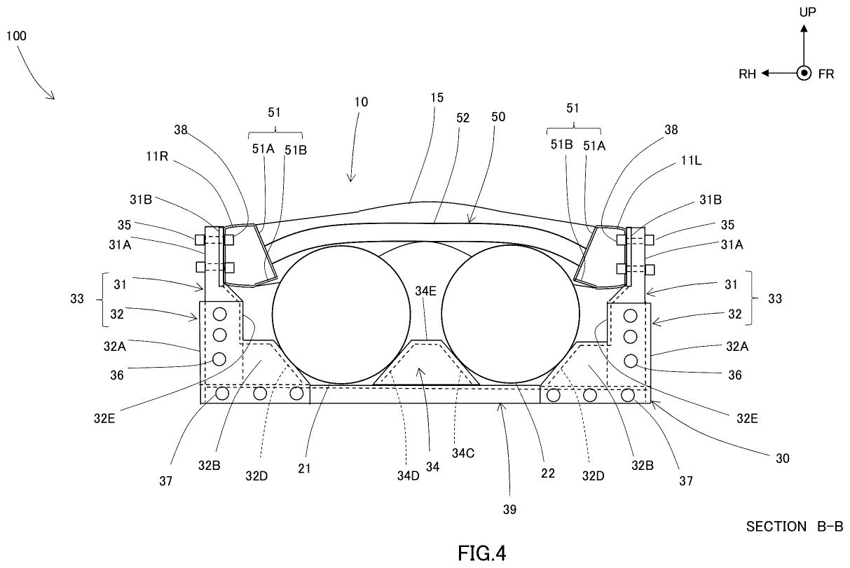

As shown in FIGS. 3 and 4, the bracket 33 on the left side of the vehicle includes an upper bracket 31 and a lower bracket 32. The upper bracket 31 is a closed cross-sectional member including a groove-shaped portion 31A and a bottom plate 31B. The upper bracket 31 is attached to the outer surfaces of the left and right side rails 11L and 11R in the vehicle width direction by a bolt 35 and a nut 38.

The lower bracket 32 on the left side of the vehicle includes an outer plate 32A, a front plate 32B, a rear plate 32C, a lid plate 32D, and an inner plate 32E, and the front plate 32B and the rear plate 32C of the lower bracket 32 are fixed to the lower portion of the upper bracket 31 by bolts 36. A lower cross rail 39 is fixed by a bolt 37 between a lower portion of the front plate 32B and a lower portion of the rear plate 32C. Hydrogen tanks 21 and 22 are mounted on the upper surface of the lower cross rail 39.

The lower half portions of the front plate 32B and the rear plate 32C project inward in the vehicle width direction, and the end portions are inclined downward. A lid plate 32D is attached to the upper surfaces of the inclined portion and the protruding portion. The upper surface of the lid plate 32D attached to the inclined portion holds the left lower portion of the left hydrogen tank 22 in the vehicle width direction.

The bracket 33 on the right side of the vehicle is bilaterally symmetrical with the bracket 33 on the left side of the vehicle. Similarly, the upper bracket 31 and the lower bracket 32 on the right side of the vehicle are also bilaterally symmetrical with the upper bracket 31 and the lower bracket 32 on the left side of the vehicle.

The upper surface of the lid plate 32D of the right lower bracket 32 holds the right lower portion of the right hydrogen tank 21 in the vehicle width direction.

A tank receiving seat 34 is attached to the center of the lower cross rail 39. The tank receiving seat 34 includes a trapezoid front plate 34A, a trapezoid rear plate 34B, an upper plate 34E, a left inclined plate 34C, and a right inclined plate 34D. The upper surface of the left inclined plate 34C holds the lower right side of the left hydrogen tank 22 in the vehicle width direction. The upper surface of the right inclined plate 34D holds the left lower portion of the right hydrogen tank 21 in the vehicle width direction.

Accordingly, the lid plate 32D of the lower half of the lower bracket 32 on the left side of the vehicle, the lid plate 32D of the lower half of the lower bracket 32 on the right side of the vehicle, and the tank receiving seat 34 constitute a stopper for defining the position of the hydrogen tanks 21 and 22 in the vehicle width direction.

The rear lower cross member 40 has the same configuration as the front lower cross member 30. As shown in FIG. 2, a reinforcing plate 11C is attached to the inner side in the vehicle width direction of the fourth cross member 15 of the left and right side rails 11L and 11R. The rear lower cross member 40 differs from the front lower cross member 30 only in that the rear lower cross member 40 is fixed to the left and right side rails 11L and 11R and the reinforcing plate 11C by bolts 35A, and the other configurations are the same as those of the front lower cross member 30 described above.

As shown in FIG. 2, the upper cross member 50 is disposed between the front lower cross member 30 and the rear lower cross member 40. Thus, the upper cross member 50 is disposed at a position different from that of the lower cross members 30 and 40 in the longitudinal direction of the vehicle.

As shown in FIGS. 2 to 4, the upper cross member 50 includes an upper cross bracket 51 and an upper cross rail 52. As shown in FIG. 4, the upper cross bracket 51 is an L-shaped cross-sectional member, and both ends of the flanges 51A and 51B are mounted between flanges of the left and right side rails 11L and 11R having a groove shape. The upper cross rail 52 is connected to the flange 51A. The upper cross rail 52 is formed of a round pipe. As shown in FIG. 4, the upper cross rail 52 extends obliquely upward in the vehicle width direction from the flange 51A and then extends in the vehicle width direction along the upper ends of the hydrogen tanks 21 and 22. In this way, the upper cross rail 52 curves upward along the cylindrical shape of the hydrogen tanks 21 and 22. The upper cross member 50 and the lower cross members 30 and 40 are connected to the left and right side rails 11L and 11R so as to surround the hydrogen tanks 21 and 22 from above and below.

As described above, in the vehicle 100, the lower cross rail 39 is disposed at a position lower than the left and right side rails 11, 11R by the bracket 33. The upper cross rail 52 is curved upward from the left and right side rails 11L and 11R to connect the left and right side rails 11L and 11R. Thereby, the torsional strength of the frame 10 can be improved. Further, since the left and right side rails 11L and 11R are used for the support structure of the hydrogen tanks 21 and 22, the weight of the vehicle 100 can be made lighter than in the case where the tank mounting frame is provided separately from the structural member of the vehicle body as in the structure described in JP2022-29621A.

Further, in the vehicle 100, the upper cross rail 52 is curved to project upward along the cylindrical shape of the hydrogen tanks 21 and 22. This makes it possible to increase the minimum ground height of the hydrogen tanks 21 and 22 while reducing the floor of the vehicle 100.

Further, since the lid plate 32D of the lower half of the lower bracket 32 on the left side of the vehicle, the lid plate 32D of the lower half of the lower bracket 32 on the right side of the vehicle, and the tank receiving seat 34 define the position of the hydrogen tanks 21 and 22 in the vehicle width direction, the hydrogen tanks 21 and 22 can be stably held in the vehicle width direction.

In the vehicle 100 described above, the two hydrogen tanks 21 and 22 are mounted. In this case, the tank receiving seat 34 may be provided on both sides of the hydrogen tank on the lower cross rail 39. Further, three or more hydrogen tanks may be mounted. In this case, the tank receiving seat 34 may be provided at positions between the hydrogen tanks on the lower cross rail 39.

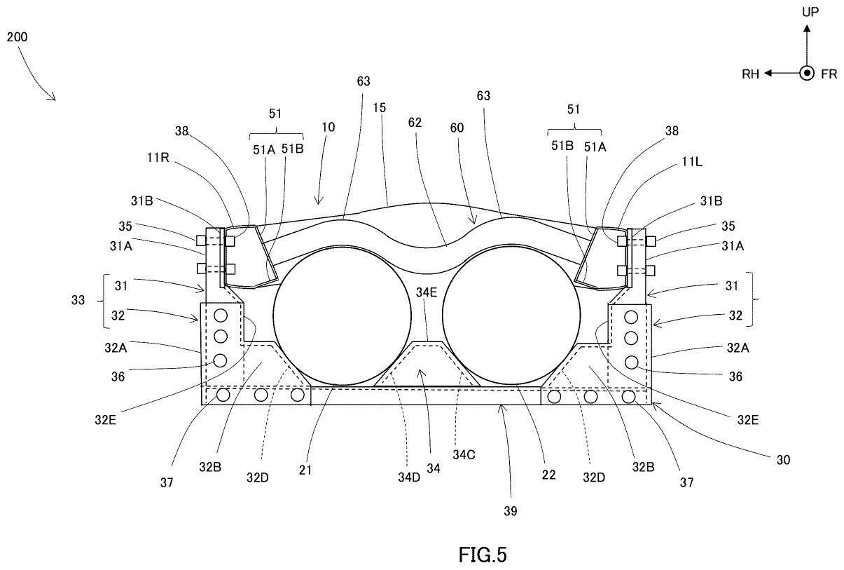

Next, a vehicle 200 according to another embodiment will be described with reference to FIG. 5. Like the vehicle 100, the vehicle 200 is a fuel cell electric vehicle in which the fuel cell 20 is mounted. The same components as those of the vehicle 100 described above with reference to FIGS. 1 to 4 are denoted by the same reference numerals, and description thereof will be omitted.

In the vehicle 200, the upper cross member 50 of the vehicle 100 is the upper cross member 60 shown in FIG. 5. As shown in FIG. 5, the upper cross member 60 includes an upper cross rail 62 and an upper cross bracket 51. The upper cross rail 62 has two curved portions 63 which are curved upward and convex along the cylindrical shape of the hydrogen tanks 21 and 22 so as to define the position of the hydrogen tanks 21 and 22 in the vehicle width direction. This makes it possible to increase the minimum ground height of the hydrogen tanks 21 and 22 while reducing the floor of the vehicle 100. Further, since the upper cross member 60 defines the position of the hydrogen tanks 21 and 22 in the vehicle width direction similarly to the lid plate 32D of the lower half of the lower bracket 32 on the left side of the vehicle, the lid plate 32D of the lower half of the lower bracket 32 on the right side of the vehicle, and the tank receiving seat 34, the hydrogen tanks 21 and 22 can be stably held in the vehicle width direction.

In the vehicle 200 described above, the two hydrogen tanks 21 and 22 are mounted. In this case, the upper cross rail 62 has one curved portion 63 which curves upward along the cylindrical shape of one hydrogen tank. Further, three or more hydrogen tanks may be mounted. In this case, the upper cross rail 62 has a plurality of curved portions 63 which are curved upward along the respective cylindrical shapes of the plurality of hydrogen tanks.

1. A fuel cell electric vehicle includes:
a pair of side rails extending along the vehicle longitudinal direction;
a lower cross member arranged below the pair of side rails to connect between the pair of side rails in the vehicle width direction;
at least one hydrogen tank mounted on the lower cross member; and
an upper cross member arranged above the hydrogen tank to connect between the pair of side rails in the vehicle width direction.

2. The fuel cell electric vehicle according to claim 1, wherein
the upper cross member and the lower cross member are disposed at different positions in the vehicle longitudinal direction.

3. The fuel cell electric vehicle according to claim 1, wherein:
the hydrogen tank has a cylindrical shape and is mounted on the lower cross member, with a longitudinal direction of the hydrogen tank aligning with the vehicle longitudinal direction, and
the upper cross member is curved in an upwardly convex shape along a cylindrical surface of the hydrogen tank.

4. The fuel cell electric vehicle according to claim 2, wherein:
the hydrogen tank has a cylindrical shape and is mounted on the lower cross member, with a longitudinal direction of the hydrogen tank aligning with the vehicle longitudinal direction, and
the upper cross member is curved in an upwardly convex shape along a cylindrical surface of the hydrogen tank.

5. The fuel cell electric vehicle according to claim 1, wherein:
the hydrogen tank has a cylindrical shape, and comprises a plurality of hydrogen tanks which are arranged side by side on the lower cross member, with a longitudinal direction of the hydrogen tank aligning with the vehicle longitudinal direction, and
the upper cross member is curved in an upwardly convex shape along a cylindrical surface of each of the plurality of hydrogen tanks so as to define the position of each of the plurality of hydrogen tanks in the vehicle width direction.

6. The fuel cell electric vehicle according to claim 2, wherein:
the hydrogen tank has a cylindrical shape, and comprises a plurality of hydrogen tanks which are arranged side by side on the lower cross member, with a longitudinal direction of the hydrogen tank aligning with the vehicle longitudinal direction, and
the upper cross member is curved in an upwardly convex shape along a cylindrical surface of each of the plurality of hydrogen tanks so as to define the position of each of the plurality of hydrogen tanks in the vehicle width direction.

7. The fuel cell electric vehicle according to claim 1, wherein:
the hydrogen tank has a cylindrical shape, and comprises a plurality of hydrogen tanks which are arranged side by side on the lower cross member, with longitudinal directions of the hydrogen tanks aligning with the vehicle longitudinal direction;
the lower cross member comprises,
brackets, each of which is attached to an outer surface of corresponding one of the side rails in the vehicle width direction and extends downward from the corresponding one of the side rails, and
a cross rail that connects between the brackets in the vehicle width direction; and
stoppers respectively attached to a lower end of each of the brackets and an upper surface of the cross rail, the stoppers being configured to define positions of the plurality of hydrogen tanks in the vehicle width direction.

8. The fuel cell electric vehicle according to claim 2, wherein:
the hydrogen tank has a cylindrical shape, and comprises a plurality of hydrogen tanks which are arranged side by side on the lower cross member, with longitudinal directions of the hydrogen tanks aligning with the vehicle longitudinal direction;
the lower cross member comprises,
brackets, each of which is attached to an outer surface of corresponding one of the side rails in the vehicle width direction and extends downward from the corresponding one of the side rails, and
a cross rail that connects between the brackets in the vehicle width direction; and
stoppers respectively attached to a lower end of each of the brackets and an upper surface of the cross rail, the stoppers being configured to define positions of the plurality of hydrogen tanks in the vehicle width direction.
